(19) United States
(12) Patent Application Publication
(10) Pub. No.: US 2011/0199012 A1
(43) Pub. Date: Aug. 18, 2011

(54) Driving Circuit For Lighting Lamp And Cold Cathode Fluorescent Lamp Using Driving Circuit Thereof

(76) Inventor: Wen-Cheng Lai, Taoyuan (TW)

(21) Appl. No.: 12/704,544

(22) Filed: Feb. 12, 2010

(51) Int. Cl. H05B 41/36

(52) U.S. Cl. 315/219; 315/307

(57) ABSTRACT

A driving circuit for lighting lamp is provided, including, in the order of, a bridge rectifier, an EMC filter, a control circuit, a power transformer and a cold cathode fluorescent load, with a feedback loop connected in series between the control circuit and the power transformer. A cold cathode fluorescent lamp using the driving circuit for lighting lamp is also provided, including a plastic lamp tube, a cold cathode fluorescent lamp tube, installation electrodes, frame and driving circuit module. Two contact electrodes are connected to the electrodes of the installation electrodes on the two ends of the plastic lamp tube for electrical connection to the conventional fluorescent lamp base. The circuit of the present invention is simple in structure, uses less number of components, is inexpensive in manufacturing, novel control mechanism and high reliable. The present invention is suitable for inserting cold cathode fluorescent lamp to the conventional fluorescent lamp base, regardless of the presence of a starter, for luminance.

### FIELD OF THE INVENTION

The present invention generally relates to a driving circuit for lighting lamp, and more specifically to a driving circuit for cold cathode fluorescent lamp.

### BACKGROUND OF THE INVENTION

Cold cathode fluorescent lamp is a new light source. Because the cold cathode fluorescent lamp ahs the advantages of thin lamp tube, simple structure, low surface temperature increase, high luminance of the tube surface, ease of customized shaping, long lifespan, good display color, uniform luminance, and so on, cold cathode fluorescent lamp is the most ideal light source for the TFT-LCD, as well as, wide popularity among applications, such as, advertisement box, scanner and other back light sources. In addition, the colorful display and low energy-consumption also make the cold cathode fluorescent lamp an ideal lighting deployment for metropolitan buildings.

The conventional driving circuit for cold cathode fluorescent lamp uses separate components to form bridge for current driving, and requires a large number of peripheral components and complicated control circuit design and tuning, in addition to the disadvantage of poor reliability. Recently, many chip companies develop single-chip driving circuit solution for cold cathode fluorescent lamp; however, these are mostly typical application circuit solution, and rarely protective circuit solution; thus, not suitable for industrial manufacturing or business.

In the current luminance applications, the conventional fluorescent lamp system is still the mainstream. The conventional fluorescent lamp system includes a fluorescent lamp, rectifier, starter, and so on. The above conventional system must include an operational starter to start the circuit, which is not suitable for the new cold cathode fluorescent lamp.

### SUMMARY OF THE INVENTION

The present invention has been made to overcome the above-mentioned drawback of conventional driving circuit for cold cathode fluorescent lamp. The primary object of the present invention is to provide a driving circuit for lighting lamp and cold cathode fluorescent lamp using the driving circuit thereof.

To achieve the above object, the present invention provides a driving circuit for lighting lamp, including a bridge rectifier, an electro-magnetic compatibility (EMC) filter, a control circuit, a power transformer and a cold cathode fluorescent load, with the following features:

the driving circuit for lighting lamp further including a feedback loop, serially connected between the control circuit and power transformer;
the rectifier including a first diode, a second diode, a third diode and a fourth diode forming a bridge circuit;
the EMC filter further including a first capacitor, a second capacitor and an inductor forming a II shape filter;
the control circuit including a control chip, a fifth diode, an eighth diode, a third capacitor, a fourth capacitor, a fifth capacitor, a first resistor, a fourth resistor and a fifth resistor, connected in the following manner:
the fifth diode being connected between the EMC filter and the control circuit, with anode connected to the output of the EMC filter and cathode being the output of the power source, and connected to the control circuit;
the first resistor, the fourth resistor and the third capacitor being connected in series, and connected to the circuit in parallel; the eighth diode and the fifth capacitor being connected in series between a sixth pin and a first pin of the control chip, the anode and the first pin of the control chip being connected in parallel to the serial connection point of the fourth resistor and the third capacitor; an eighth pin of the control chip being connected to the serial connection point of the eighth diode and the fifth capacitor;
the fifth resistor and the fourth capacitor being connected in series between a second pin and ground of the control chip, a third pin of the control chip being connected to the serial connection point of the fifth resistor and the fourth capacitor; and
a fourth pin of the control chip being connected to ground;
the power transformer including a sixth resistor, a seventh resistor, a first field-effect transistor (FET), a second FET, a seventh capacitor, an eighth capacitor, a booster transformer and an isolation transformer, connected in the following manner:
the first FET, the second FET, the seventh capacitor and the eighth capacitor being connected in parallel and to the circuit, drain of the first FET, source of the second FET and one end of primary winding of the booster transformer being connected in parallel to the sixth pin of the control chip;
the other end of the primary winding of the booster transformer being connected to the serial connection point of the seventh capacitor and the eighth capacitor;
primary winding of the isolation transformer being connected correspondingly to secondary winding of the booster transformer, and secondary power output end and the cold cathode fluorescent load being connected in parallel, the seventh resistor being connected in series between the seventh pin of the control chip and gate of the first FET; and
the sixth resistor being connected in series between the fifth pin of the control chip and gate of the second FET;
the feedback loop including a sixth capacitor, a sixth diode, a seventh diode, being connected in the following manner: the sixth diode and the seventh diode being connected in series to two ends of the third capacitor of the control circuit, cathode of the seventh diode being connected to anode of the third capacitor and anode of the sixth diode being connected to cathode of the third capacitor, the sixth capacitor being connected in series between the serial connection point of the sixth diode and the seventh diode and the serial connection point of the seventh capacitor and the eighth capacitor of the power transformer;
the cold cathode fluorescent load including a cold cathode fluorescent lamp with two contact electrodes electrically connected to output of the isolation transformer;
the cold cathode fluorescent lamp including a lamp shell and a cold cathode fluorescent lamp tube, cold cathode fluorescent lamp tube being placed inside the lamp shell;
inside of the lamp shell further including a circuit board electrically connected to the cold cathode fluorescent lamp tube, cold cathode fluorescent lamp tube being load of the circuit board;
a reflective plate being placed between the circuit board and the cold cathode fluorescent lamp tube, and the reflective plate being connected to the lamp shell;
two ends of the lamp shell having contact electrodes, with one end connected to the circuit board and the other connected to external power source; and
the lamp shell being made of transparent material.

The advantages of the present invention includes:
1. The driving circuit of the present invention is simple in structure, uses a small number of components and can be manufactured inexpensively;
2. The driving circuit of the present invention is novel, reliable, and uses less peripheral components for feedback loop to realize the effective control over the load voltage and current; and
3. The cold cathode fluorescent lamp can be easily loaded into the conventional fluorescent lamp base, and regardless of the presence of the starter on the base, the cold cathode fluorescent lamp can laminate; hence, the present invention can replace the conventional fluorescent lamp and is suitable for industrial, business and household use to realize green luminance to save energy.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the driving circuit for lighting lamp according to the invention;

FIG. 2 shows a schematic view of the cold cathode fluorescent lamp of the present invention.

### DETAILED DESCRIPTION OF THE PREFERRED EMBODIMENTS

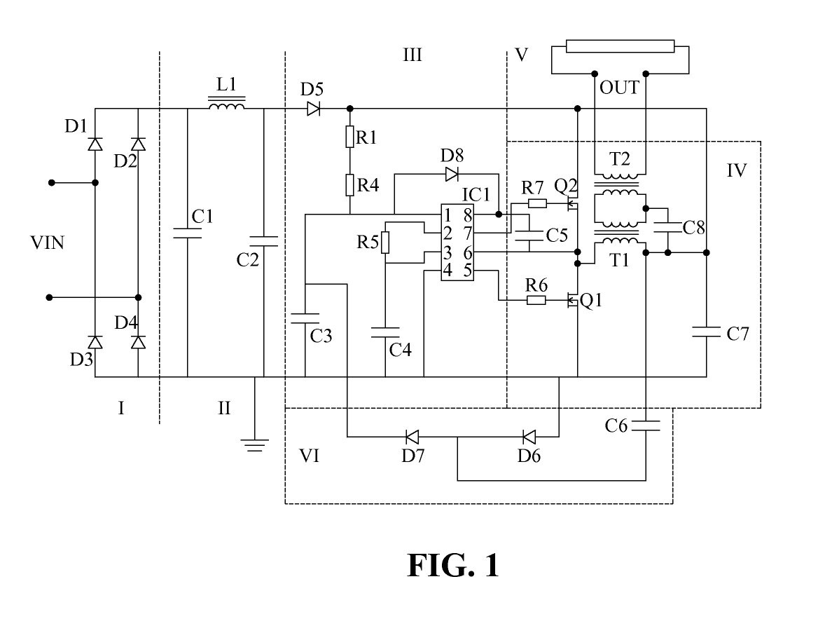

FIG. 1 shows a schematic view of the driving circuit of the lighting lamp according to the invention. As shown in FIG. 1, the driving circuit for lighting lamp includes, in the order of, a bridge rectifier I, an electro-magnetic compatibility (EMC) filter II, a control circuit III, a power transformer IV and a cold cathode fluorescent load V. A feedback loop VI is further serially connected between control circuit III and power transformer IV.

Rectifier I includes a first diode D1, a second diode D2, a third diode D3 and a fourth diode D4 forming a bridge circuit to rectify the 220V alternating current (AC) into direct current (DC). EMC filter II further includes a first capacitor C1, a second capacitor C2 and an inductor L1 forming a II shape filter, connected to output of bridge rectifier I to filter the noise from the rectified DC to improve the stability of the DC.

Control circuit III includes a control chip IC1, a fifth diode D5, an eighth diode D8, a third capacitor C3, a fourth capacitor C4, a fifth capacitor C5, a first resistor R1, a fourth resistor R4 and a fifth resistor R5. Fifth diode D5 is connected between EMC filter II and control circuit III, with anode connected to output of EMC filter 11 and cathode being the output of the power source, and connected to control circuit III. First resistor RE fourth resistor R4 and third capacitor C3 are connected in series, and are connected to the circuit in parallel. Eighth diode D8 and fifth capacitor C5 are connected in series between a sixth pin and a first pin of control chip ICE with anode and the first pin of control chip IC1 being connected in parallel to the serial connection point of fourth resistor R4 and third capacitor C3. An eighth pin of control chip IC1 is connected to the serial connection point of eighth diode D8 and fifth capacitor C5. Fifth resistor R5 and fourth capacitor C4 are connected in series between a second pin and ground of control chip IC1. A third pin of control chip IC1 is connected to the serial connection point of fifth resistor R5 and fourth capacitor C4. A fourth pin of control chip IC1 is connected to the ground.

Power transformer IV includes a sixth resistor R6, a seventh resistor R7, a first field-effect transistor (FET) Q1, a second FET Q2, a seventh capacitor C7, an eighth capacitor C8, a booster transformer T1′ and an isolation transformer T2, connected in the following manner. First FET Q1, second FET Q2, seventh capacitor C7 and eighth capacitor C8 are connected in parallel and to the circuit. Drain of first FET Q1, source of second FET Q2 and one end of primary winding of booster transformer T1 are connected in parallel to the sixth pin of control chip IC1. The other end of primary winding of booster transformer T1 is connected to the serial connection point of seventh capacitor C7 and eighth capacitor C8. Primary winding of isolation transformer T2 is connected correspondingly (i.e., ends with same name connected correspondingly) to secondary winding of booster transformer T1. Second winding of isolation transformer T2 is power output OUT of the present invention, and is connected to cold cathode fluorescent load V in parallel. Seventh resistor R7 is connected in series between the seventh pin of control chip IC1 and gate of first FET Q1. Sixth resistor R6 is connected in series between the fifth pin of control chip IC1 and gate of second FET Q2.

Feedback loop VI includes a sixth capacitor C6, a sixth diode D6, a seventh diode d7, connected in the following manner. Sixth diode D6 and seventh diode D7 are connected in series to two ends of third capacitor C3. Cathode of seventh diode D7 is connected to anode of third capacitor C3 and anode of sixth diode D6 is connected to cathode of third capacitor C3. Sixth capacitor C6 is connected in series between the serial connection point of sixth diode D6 and seventh diode D7, and the serial connection point of seventh capacitor C7 and eighth capacitor C8. Feedback loop VI realizes the control over of the current from the output transformer to automatically light up the cold cathode fluorescent lamp.

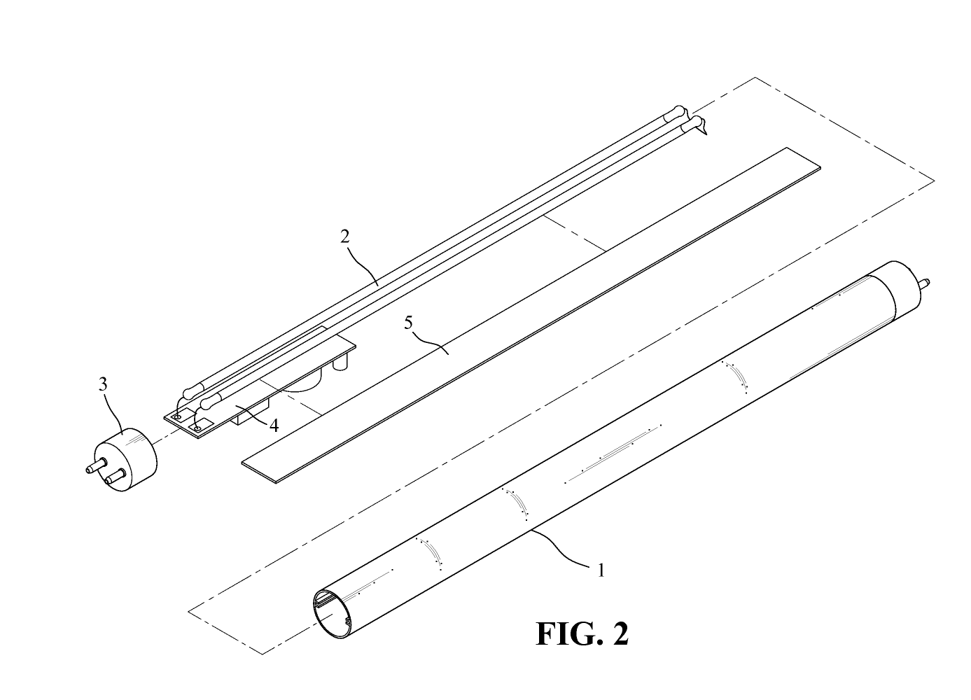

FIG. 2 shows a schematic view of the cold cathode fluorescent lamp of the present invention. As shown in FIG. 2, the cold cathode fluorescent lamp includes a lamp shell 1 and a cold cathode fluorescent lamp tube 2, with two contact electrodes on two ends of cold cathode fluorescent lamp tube 2. Cold cathode fluorescent lamp tube 2 is placed inside lamp shell 1. Inside of the lamp shell further includes a circuit board 4 electrically connected to cold cathode fluorescent lamp tube 2. Cold cathode fluorescent lamp tube 2 is the load of circuit board 4.

A reflective plate 5 is placed between circuit board 4 and cold cathode fluorescent lamp tube 2, and reflective plate 5 is connected to inside of lamp shell 1. Reflective plate 5 is for focusing the light to increase luminance.

Two ends of lamp shell 1 have contact electrodes 3, with one end connected to circuit board 4 and the other connected to external power source.

Lamp shell 1 is made of transparent material, such as, glass or PVC, with transmittance at least 50% or higher.

When the cold cathode fluorescent lamp is inserted into a conventional fluorescent lamp base, the power is transmitted to driving circuit from the contact electrodes, through rectifying, filtering, control, power transformation to drive the load of cold cathode fluorescent lamp for luminance, regardless of the presence of a starter. In the mean time, because the feedback loop is added to the driving circuit, the luminance is easier and more stable for the driving of cold cathode fluorescent lamp.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A driving circuit for lighting lamp, comprising in the order of: a bridge rectifier, an electro-magnetic compatibility (EMC) filter, a control circuit, a power transformer and a cold cathode fluorescent load, with the following features:
said driving circuit for lighting lamp further comprising a feedback loop, serially connected between said control circuit and said power transformer;
said rectifier comprising a first diode, a second diode, a third diode and a fourth diode forming a bridge circuit; and
said EMC filter further comprising a first capacitor, a second capacitor and an inductor forming a II shape filter.

2. The driving circuit for lighting lamp as claimed in claim 1, wherein said control circuit further comprise a control chip, a fifth diode, an eighth diode, a third capacitor, a fourth capacitor, a fifth capacitor, a first resistor, a fourth resistor and a fifth resistor, connected in the following manner:
said fifth diode being connected between said EMC filter and said control circuit, with anode connected to output of said EMC filter and cathode being output of power source, and connected to said control circuit;
said first resistor, said fourth resistor and said third capacitor being connected in series, and connected to said circuit in parallel; said eighth diode and said fifth capacitor being connected in series between a sixth pin and a first pin of said control chip, anode and said first pin of said control chip being connected in parallel to serial connection point of said fourth resistor and said third capacitor; an eighth pin of said control chip being connected to serial connection point of said eighth diode and said fifth capacitor;
said fifth resistor and said fourth capacitor being connected in series between a second pin and ground of said control chip, a third pin of said control chip being connected to serial connection point of said fifth resistor and said fourth capacitor; and
a fourth pin of said control chip being connected to ground.

3. The driving circuit for lighting lamp as claimed in claim 1, wherein said power transformer comprises a sixth resistor, a seventh resistor, a first field-effect transistor (FET), a second FET, a seventh capacitor, an eighth capacitor, a booster transformer and an isolation transformer, connected in the following manner:
said first FET, said second FET, said seventh capacitor and said eighth capacitor being connected in parallel and to said circuit, drain of said first FET, source of said second FET and one end of primary winding of said booster transformer being connected in parallel to said sixth pin of said control chip;
the other end of primary winding of the booster transformer being connected to serial connection point of said seventh capacitor and said eighth capacitor;
primary winding of said isolation transformer being connected correspondingly to secondary winding of said booster transformer, and secondary power output end and said cold cathode fluorescent load being connected in parallel, said seventh resistor being connected in series between seventh pin of said control chip and gate of said first FET; and
said sixth resistor being connected in series between fifth pin of said control chip and gate of said second FET.

4. The driving circuit for lighting lamp as claimed in claim 1, wherein said feedback loop comprises a sixth capacitor, a sixth diode, a seventh diode, being connected in the following manner:
said sixth diode and the seventh diode being connected in series to two ends of said third capacitor of said control circuit, cathode of said seventh diode being connected to anode of said third capacitor and anode of said sixth diode being connected to cathode of said third capacitor; said sixth capacitor being connected in series between serial connection point of said sixth diode and said seventh diode and serial connection point of said seventh capacitor and said eighth capacitor of said power transformer.

5. The driving circuit for lighting lamp as claimed in claim 1, wherein said cold cathode fluorescent load comprises a cold cathode fluorescent lamp with two contact electrodes electrically connected to output of said isolation transformer.

6. A cold cathode fluorescent lamp using the driving circuit for lighting lamp as claimed in claim 1, comprising a lamp shell and a cold cathode fluorescent lamp tube, said cold cathode fluorescent lamp tube being placed inside said lamp shell, with main features as following:
inside of said lamp shell further having a circuit board electrically connected to said cold cathode fluorescent lamp tube, said cold cathode fluorescent lamp tube being load of said circuit board.

7. The cold cathode fluorescent lamp as claimed in claim 6, wherein a reflective plate is placed between said circuit board and said cold cathode fluorescent lamp tube, and said reflective plate is connected to inside of said lamp shell.

8. The cold cathode fluorescent lamp as claimed in claim 6, wherein two ends of said lamp shell have contact electrodes, with one end connected to said circuit board and the other connected to external power source.

9. The cold cathode fluorescent lamp as claimed in claim 6, wherein said lamp shell is made of transparent material.
